(19) United States
(12) Patent Application Publication
(10) Pub. No.: US 2009/0254933 A1
(43) Pub. Date: Oct. 8, 2009

(54) Media detection using acoustic recognition

(76) Inventors: Vishwa Nath Gupta, Broussard (CA); Gilles Boulianne, Saint-Pie (CA); Patrick Kenny, Montreal (CA); Pierre Dumouchel, Montreal (CA)

Correspondence Address: ABELMAN, FRAYNE & SCHWAB, 666 THIRD AVENUE, 10TH FLOOR, NEW YORK, NY, 10017, US

(21) Appl. No.: 12/383,765

(22) Filed: Mar. 27, 2009

Related U.S. Application Data
(60) Provisional application No. 61/039,999, filed on Mar. 27, 2008.

(51) Int. Cl. H04H 60/32

(52) U.S. Cl. 725/14; 725/18

(57) ABSTRACT

A method and system for detecting certain types of content, such as advertisements, using acoustical means from a media stream. The method uses two matching processes to detect and identify repeated content, the starting and end boundaries of which are then found. This content is used as the basis to find non-repeated content (such as less-frequently repeated advertisements) that are typically located in proximity to repeated content and can be evaluated using Gaussian mixture models (GMMs). The system that implements this method can be used for advertisement detection and monitoring for traditional media, such as television and radio, as well as for Internet-based media, such as streaming video, streaming audio and podcasts. The system can also be used to detect and identify copyrighted material in Internet traffic.

### CROSS-REFERENCE TO RELATED APPLICATIONS

This application claims the benefit under 35 USC 119(e) of U.S. Provisional Patent Application 61/039,999 filed on Mar. 27, 2008 and hereby incorporated by reference herein.

### FIELD OF THE INVENTION

The invention generally relates to the field of digital media detection, identification and classification through acoustic means.

### BACKGROUND OF THE INVENTION

In many countries and regions, the transmission of mass-media (such as radio and television (TV)) is provided to the public at no cost, aside from that for the equipment needed to receive and/or decode such signals, such as radio receivers and televisions. The cost for the production and transmission of such signals by mass-media outlets (such as radio and TV stations) is typically borne by advertisers, who pay to have advertisements featuring their products and services broadcast to the public by these outlets.

In this arrangement, the advertiser typically contracts a mass-media outlet, such as a TV station, to repeat an advertisement a certain number of times over a specified time period, such as to repeat a 30-second advertisement 3 times per hour. The advertiser may also make certain demands regarding the repetition and/or placement of their advertisements, such as to increase the frequency of repetition during a particular show that they know is popular with their existing and/or potential customers. In response, the mass-media outlet may charge different prices to advertisers depending on the desired frequency and/or placement of their advertisements.

The business model described above for traditional media has evolved over many years, but similar business models are seen to be evolving in the new media space, such as for streaming audio and video sent via the Internet. As a result, repeated advertisements are beginning to appear within streaming video (such as for How-To videos) as well as for streaming audio and/or podcasts since they can be sold to advertisers in much the same fashion.

Although advertisers are willing to pay to have their advertisements appear through mass-media and/or new media outlets, there is also a need to ensure that such outlets keep their part of the bargain. For example, if an advertiser contracts a radio station to increase the frequency of a certain advertisement from 3 times per hour to 5 times per hour during the station's morning show, the advertiser should ensure that the frequency of this advertisement is indeed 5 times per hour. Otherwise, the advertiser may not be receiving the most cost-effective use of their marketing budget.

This verification process can be complicated by the sheer number of outlets over which an advertisement may be broadcast, as well as particular differences in the contractual obligations between each advertiser and outlet. For example, a small business in a single urban market may advertise on the local TV station and radio station, which can be monitored by the business owner themselves. However, a medium- or large-sized business may potentially deal with hundreds or even thousands of stations and channels nationally and/or internationally, and the scope of such monitoring is likely to be beyond their ability.

As a result, there is a need to monitor media outlets to detect, identify and classify certain content (such as advertisements) in order to verify when, where and how often such media appeared.

### SUMMARY OF THE INVENTION

In accordance with a broad aspect, the present invention provides a system, comprising a processing entity that is operative for i) receiving a media stream comprising an audio segment and ii) performing a searching operation on an audio stream, the searching operation being operative for identifying a match to the audio segment within the audio stream, as well as an output operative for conveying information indicative of the results of the searching operation.

In accordance with another broad aspect, the present invention provides a method, comprising a) receiving at a processing entity a media stream comprising an audio segment, b) performing a searching operation on an audio stream, the searching operation being operative for identifying a potential match to the audio segment within the audio stream, and c) conveying information indicative of the results of the searching operation.

In accordance with yet another broad aspect, the present invention provides a system comprising a processing entity operative for: i) receiving a first media broadcast and a second media broadcast and ii) identifying advertisement content in the first media broadcast by detecting audio segments in the first media broadcast that match audio segments in the second media broadcast, as well as an output operative for conveying information indicative of identified advertisement content.

In accordance with still yet another broad aspect, the present invention provides a method, comprising: a) receiving at a processing entity a first media broadcast and a second media broadcast and b) identifying advertisement content in the first media broadcast by detecting audio segments in the first media broadcast that match at least one audio segment in the second media broadcast.

In accordance with still yet another broad aspect, the present invention provides a system comprising a processing entity operative for i) receiving a media broadcast comprising programming content and advertisement content and ii) processing the media broadcast using a Gaussian Mixture Model (GMM) in order to discriminate between programming content and advertisement content, as well as an output operative for conveying information indicative of the discrimination between the programming content and advertisement content.

In accordance with still yet another broad aspect, the present invention provides a method comprising: a) receiving at a processing entity a media broadcast comprising programming content and advertisement content and b) processing the media broadcast using a Gaussian Mixture Model (GMM) in order to discriminate between programming content and advertisement content.

### BRIEF DESCRIPTION OF THE DRAWINGS

FIG. 1 is a block diagram showing the general steps of the method according to a specific example of implementation of the invention;

FIG. 2 is a diagram of a process in which audio segments from two audio streams are being compared within the same stream, as well as in the other audio stream;

FIG. 3 is a diagram of two audio streams wherein two offset audio segments are matched using the method illustrated in FIG. 1;

FIG. 4 is a block diagram showing a general procedure that can be used to find the start and end points for matching audio segments according to a non-limiting example of implementation of the invention;

FIGS. 5A, 5B and 5C show an implementation of the procedure illustrated in FIG. 4;

FIG. 6 is a block diagram showing a method that can be used to classify non-repeating audio segments according to a non-limiting example of implementation of the invention;

FIG. 7 is a diagram of four audio streams containing repeating and non-repeating audio segments;

FIG. 8 is a block diagram showing the components of a system embodied within the invention;

FIG. 9 is a block diagram showing a system an example of implementation of the invention, the system being used for tracking the broadcasting of ads; and

FIG. 10 is a block diagram showing a system according to another example of implementation of the invention, the system being used for performing digital rights management.

### DETAILED DESCRIPTION

As used here, the term “media stream” refers to the audio (with or without video) content that is transmitted through a medium such as radio (e.g., from a radio station), television (e.g., from a Television station) or the Internet (e.g., a stream from an Internet radio station or video streaming service, such as Google YouTube), or a local source, such as a machine readable storage medium in which the media stream is stored. Media streams may be analog or digital in nature, transmitted via wired or wireless means and may be received and decoded using equipment and techniques that are known in the art.

A media stream for a transmission may be thought of as being comprised of an audio stream that contains the auditory portion of the transmission, and optionally, a video stream that contains the visual portion of the transmission. In certain cases, (e.g., radio transmissions or podcasts), only the audio stream is broadcast whereas in other cases (e.g., TV transmission, streaming video or video podcasts), the video and audio streams are broadcast. In those instances, the media stream contains only an audio stream without any video content.

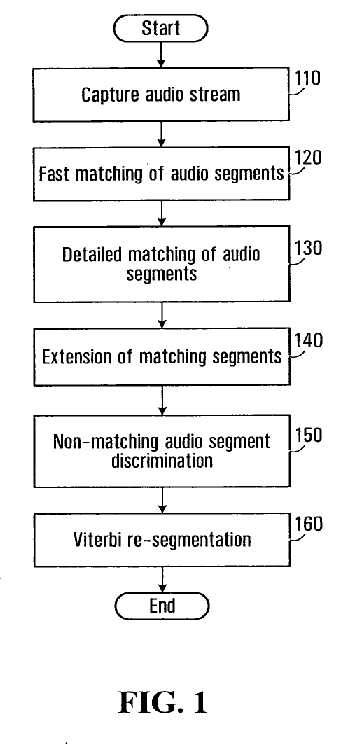

FIG. 1 illustrates the general steps involved in a method for detecting repeating audio content, which will be introduced briefly here. At Step 110, an audio stream is received and captured using equipment and methods that are well known in the art. For this reason, the capture operation will not be described in detail. However, it should be noted that the capture operation may involve buffering of the audio steam or recording of the audio stream in a machine-readable storage medium.

At step 120, certain media segments within the audio stream are subjected to a ‘fast match’ process that quickly identifies portions of the audio stream that match with portions of one or more other audio streams. For example, a portion of an advertisement that is played repeatedly on a given radio station, will match previous audio segments within that audio stream, since the advertisement is repeatedly played. In a specific example, the algorithm underlying this process can detect matching audio content within a single audio stream or across multiple audio streams soon after such content has been received (i.e. essentially in real-time).

At step 130, the media segments identified by the fast-match algorithm as having matching audio content (i.e., repeating content) are verified by a ‘detailed match’ process to eliminate false positive results that may have been returned by the fast-match procedure.

At step 140, media segments verified by the detailed match process as having matching content are subjected to an extension process to identify their respective start and end points. This allows the total duration of the audio content that includes the matching segment to be identified.

At step 150, media segments that were not identified as matching are subjected to a discrimination process to determine their likely content. In other words, any non-matching segments of the audio stream are compared against various characteristic profiles that are common for given types of audio content such as programming or advertising. In this manner, even a non-repeating advertisement can be identified and categorized as an advertisement using this non-matching audio segment discrimination.

At step 160, the matching and non-matching content belonging to a certain category (such as advertisements) are segmented for further analysis and/or processing. For example, this re-segmentation process may be performed on all audio segments that have been classified as containing advertisement content, in order to determine more precisely the start and end boundaries associated with these media segments.

Further details for each step in the above method are presented below.

### Reception, Capture and Buffering of Media Stream(s)

At step 110, a media stream provided by a content provider (such as a radio or TV station) is received and captured, and its audio stream subsequently prepared for analysis using the method.

If the supplied media stream contains only audio content (e.g., transmissions from radio stations or Internet radio stations) they can be considered audio streams and no subsequent preparation is needed. If the supplied media stream contains both video and audio content, such as transmissions from TV stations or streaming video, then the audio stream could be extracted from the media stream for ease of processing. This can be done by splitting the media stream into its respective video and audio streams using methods and techniques known in the art. Although the audio and video streams are now separate, certain timing information (such as timecode) may be retained in the audio stream such that content in the audio stream can be subsequently synchronized with events (such as video frames) in the video stream at a later time.

Media streams are typically supplied in real-time, such as from a live feed supplied by a television or radio station. In such a case, a pre-determined amount of the media stream can be stored in a storage media, such as in a memory buffer, in order that the audio stream can be extracted and then analyzed. The amount of the media stream that is stored or buffered for analysis at any one time may be determined through a pre-determined setting or dynamically by a system used to implement this method, which will be introduced later.

Alternatively, a media stream may not be supplied in real-time, such as a media stream supplied by an analog recording from media such as tape (e.g., “log tapes” of a radio station or TV station) or digital media, such as motion video files (e.g., DVDs, MPEG-4 video files or Adobe Flash video files). In such a case, the media stream being analyzed may not need to be stored as the content is available in its entirety from an existing storage media.

Since the means and techniques by which an audio stream may be received, extracted and stored are likely well known in the art, further details for this step need not be provided.

### Fast-Matching of Repeated Content

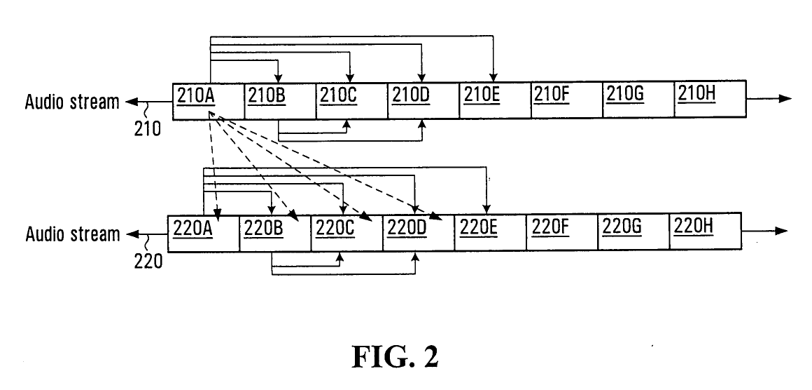

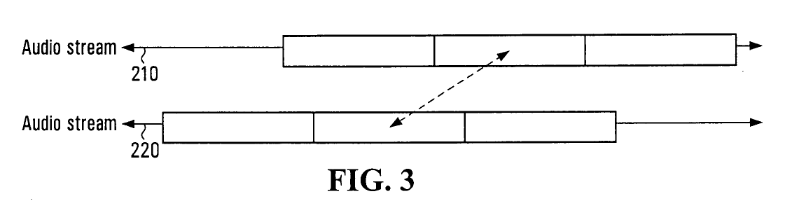

At step 120, a certain type of content that may be repeated within an audio stream (or streams) is identified using a ‘fast-matching’ process. FIG. 2 illustrates the fast-matching process for two audio streams 210 and 220.

In order to detect repeated content within each audio stream, the buffered content of that stream is divided into non-overlapping audio segments of a predetermined length, such as consecutive 5-second segments, but that time can vary without departing from the spirit of the invention. The length of each audio segment should reflect a timeframe that is known to be generally sufficient to identify the repeated content. Advertisement is an example of a content that is typically repeated in a media stream and which can be identified on the basis of repetition.

To detect advertisements within an audio stream for example, it would be considered reasonable to set the duration of each audio segment at 5 seconds since advertisements generally are between 10 to 30 seconds long.

For example, assume that 40 seconds worth of content is buffered for the audio streams 210 and 220 during step 110. Conceptually, the content for the audio stream 210 may be divided into eight 5-second segments of equal duration, namely segments 210A through 210H. Likewise, the audio stream 220 can be divided into a similar number of audio segments, namely segments 220A through 220H. Although 5-second audio segments are used in this example to detect advertisements, this value is used for illustrative purposes only and segments with other durations would also fall within the scope of this invention.

Each audio segment can be correspondingly sub-divided into a number of frames of consistent duration, such as individual frames of 10 milliseconds (ms) duration. Thus a 5-second segment, such as the segment 210A, can be seen as comprising 500 individual frames of equal duration, such as frames 210A₀₀₁, 210A₀₀₂ and 210_{A003} up to 210A₅₀₀. Although 10 ms frame durations are used here for illustration, other frame durations are possible without departing from the spirit of the invention.

Once an audio stream is divided into consecutive segments and frames of equal duration, the acoustic content of each audio segment and frame can then be compared against future segments and frames in the same stream, as well as against segments and frames in other audio streams, in order to determine if its content is repeated elsewhere.

In other words, the process is such that every audio segment of a given audio stream is compared to any other audio segment in the each audio stream. The number of audio streams that can be processed in this fashion in real- or quasi-real time depends on the available computational resources. In this fashion, repeating content can be identified as such when matching audio segments are found across audio streams and not necessarily within the same audio stream.

FIG. 2 illustrates this process at a macro level, whereby certain audio segments in one audio stream appear to be compared to later segments in the same stream as well as audio segments in other audio streams. For example, the content of a segment 210A in an audio stream 210 is compared against later segments (210B, 210C, and so on) in the same audio stream, as well as against segments (e.g., 220A, 220B, and so on) in the audio stream 220.

While this is illustrative of the operation of the fast-matching process at a macro level, it is not known a priori where repeating content in later segments, and/or segments in other streams, may occur. Thus, any meaningful comparison of audio content between two audio segments must be done at the level of the frame rather than at the segment level.

In particular, the process by which two separate audio segments can be compared, in the same audio stream or in different audio streams are based on certain characterization data extracted from the frames of each segment. From a process perspective, comparisons can be made between the frames in a first audio segment and the frames in a second audio segment that follows.

Consider the case of the comparison of two audio segments in the same stream, such as the segments 210A and 210B in the audio stream 210. Certain characterization data for all 500 frames within this audio segment may become known through a technique that will be explained below. To determine whether the segment 210B contains the same content as segment 210A (i.e., the content is repeated), each frame in this segment (namely, the frames 210B₀₀₁ to 210B₅₀₀) must be compared against the characterization data of its corresponding frame in the segment 210A, namely, the frames 210A₀₀₁ to 210A₅₀₀.

Each of the 500 frames in the respective audio segments 210A and 210B can be represented by one value, in particular a KL2 metric that will be explained later. Thus, the comparison operation to compare the audio segment 210A with the segment 210B simply computes the absolute sum of the differences between the corresponding frames and then measures this against a threshold value. If this sum is less than the threshold value, it can be concluded that the audio segment 210A matches the segment 210B and the content is repeated.

This threshold used to judge whether two audio segments contain repeated content is generally calculated as a fraction of the absolute sum of the 500 values in the segment 210A. In general, a threshold value of 10% of this sum has been found to give good results, although other values are possible.

In a similar fashion, it is possible to match content from the audio segment 210A to other segments in the stream by advancing segment 210B by one frame (i.e., comparing it to frame 210C₀₀₁ in the segment 210C). In this fashion, the audio segment 210A can be compared to all the 500-frame segments obtained by advancing segment 210B one frame at a time until the end of segment 210H (i.e., the frame 210H₅₀₀) is reached. Based on the example shown in FIG. 2, there will be 3,000 such segment comparisons made.

It will be appreciated that similar comparison operations can be performed for each audio segment against later segments in the audio stream 210. Thus, the content of the audio segment 210B may be compared in a similar fashion against each segment obtained by advancing segment 210C by one frame until the end of segment 210H is reached. Note that in this case, however, the number of segment comparisons between the audio segment 210B and the other segments in the audio stream 210 will be 2,500 in total.

Next, consider the case where audio segments in different streams are compared, such as the two audio segments 210A and 220A. The two segments may be compared in the same fashion as above, namely by taking the absolute sum of the differences in the corresponding frame values and comparing it against a threshold value. In addition, the same threshold value can be used to determine whether these two segments are same or not and so determine whether they contain repeated content. Thus, it can be determined if the content of the frames comprising the audio segment 220A contain the same content as that in the audio segment 210A.

A similar procedure may be used performed to compare the segment 210A against other segments in the audio stream 220 by advancing segment 220A by one frame each time until the end of segment 220H (i.e., the frame 220H₅₀₀) is reached. As a result, it can be determined whether content contained within a segment in one audio stream is repeated within another audio stream. In this case, the number of comparisons between the audio segment 210A and the audio stream 220 is 3,500.

In the two cases presented above, a comparison between two segments involves absolute sum of the differences between the corresponding frame values for each individual frame in an audio segment. Those skilled in the art will see that it may not be necessary to take the absolute sum over each and every frame in the audio segment to determine whether its content is repeated, and that sums involving fewer frames would yield the same result. For example, it may only be necessary to take absolute sum of every second or third frame difference of corresponding frames in an audio segment to determine whether two audio segments contain identical (i.e., repeated) content, such as an advertisement.

The characterization data for a frame in the segment may be computing values for certain cepstral coefficients, as well as for logarithmic energy. For example, 12 cepstral coefficients together with a logarithmic energy feature using a 25 millisecond (ms) Hamming window and a 10 ms frame advance (which is discussed later) may be extracted from a segment. A KL2 metric for each frame using two adjacent sliding 2-second audio windows can then be computed, the boundary of which is located at the center of the frame.

The symmetric KL2 metric [6] between these two adjacent sliding 2-sec windows can be found using the following formula:

$$KL 2 ( i , j ) = \frac{{σ}_{i}^{2}}{{σ}_{j}^{2}} + \frac{{σ}_{j}^{2}}{{σ}_{i}^{2}} + {( {μ}_{i} - {μ}_{j} )}^{2} ( \frac{1}{{σ}_{i}^{2}} + \frac{1}{{σ}_{j}^{2}} ) - 2$$

where μᵢ and σᵢ are the mean and standard deviation for the cepstral coefficients for the adjacent 2-second window to the left of the current frame, and μⱼ and σⱼ are the mean and standard deviation for the cepstral coefficients for the adjacent 2-second window to the right of the current frame.

In general, higher values for this metric indicate increasingly different adjacent windows, while smaller values indicate increasingly similar adjacent windows. Although the content within a segment may have been subjected to certain conditions that resulted in spectral distortion being introduced, these relations are likely to still hold, as their adjacent 2-second windows are likely to have experienced the same distortion.

To determine the degree of similarity between two audio segments, the sum of absolute difference between these KL2 values is computed for each of their corresponding frames when aligned linearly. A match (in other words, repeated content) is determined when this sum is below a preset threshold for the two audio segments, which may be set relative to the sum of the KL2 values for the segments being analyzed. Therefore, if the sum of the absolute differences is less than this threshold, then the two audio segments may be considered a match.

A threshold of 10% for the sum of absolute difference between these KL2 values may generally be sufficient to indicate a match between two 5-second audio segments, since this value helps to avoid missed segments while keeping false alarms at a low level. The threshold value listed above was determined as a result of testing the algorithm underlying the fast-matching process with a development set of French-based audio programming that contained repeated advertisements.

The table below shows the results for the fast-matching search process algorithm with a development set of programming that included repeated and non-repeated advertisements. When repeated audio within the same audio stream was sought using this algorithm, 681 repeated 5-second audio segments were found in the development set, with 140 false positives (row 1). When repeated audio was searched for within the same audio as well as across audio streams within the development set, 1,665 repeated 5-second audio segments were found, out of which 319 were false positives (row 2). It should be noted that repeated segments in the same TV channel (and not across TV channels) were searched for because recording dates for the different TV channels were very different. The fast matching process did not miss any repeated ads in this case. Note that the total duration of the matching 5 second segments of advertising in the development set is 112 minutes while the total duration of advertisements within the development set was 233 minutes. In this data, approximately 40% of the advertisements were not repeated, 25% of the 5-sec repeated segments were lost because they straddle the boundaries of the advertisements, while 5% was gained due to repeated program segments.

| | Total matching | False | % False |
|---|---|---|---|
| | segments | Positives | Positives |
| self only | 681 | 140 | 20.6 |
| self + dev set | 1665 | 319 | 19.2 |

It should be noted that the KL2 metric for each frame within an audio segment need be computed only once. This value can then be reused many times during comparison between segments involving this frame. Therefore, comparing two 5-second segments requires 1,000 additions and a comparison. Since the segment is advanced by one frame each time, this implies 1,000 additions and a comparison per frame.

### Detailed Matching of Repeated Content

The result of the fast-matching process performed at step 120 was that certain audio segments were identified as potentially having repeated content, such as advertisements. At step 130, these audio segments are subjected to a “detailed-matching” process that compares them in greater detail so as to provide more confidence that they do indeed contain repeated content.

The detailed-matching process may extract and use considerably more information from an audio segment than that used for the fast-matching process. In a specific example, this process may extract and evaluate 26 dimensional feature vectors, including 12 cepstral coefficients, the log energy and 13 delta coefficients per frame of an audio segment.

The score for the detailed-matching process between two segments is computed as the absolute sum of the differences of the corresponding features for each linearly aligned frame in the segment. The alignment between audio segments may also be varied by +/−2 frames in order to get a finer alignment between matching audio segments.

The alignment giving the minimum score is compared against a threshold set for a positive match, which could be set to 50% of the absolute sum of the cepstral coefficients of the frames. This value was derived from testing with a development set of programming containing advertisements that showed that such a threshold value gave little false alarms in the development set, and also did not miss a significant number of valid repetitions of ads in the audio segments identified as matching by the fast-matching process.

### Extension of Matching Content

The result of step 130 is the confirmation by the detailed-matching process that certain audio segments within the audio stream (or across audio streams) contain content, such as advertisements, that is repeated. At step 140, these segments are extended in order to find the actual starting and ending points of their content.

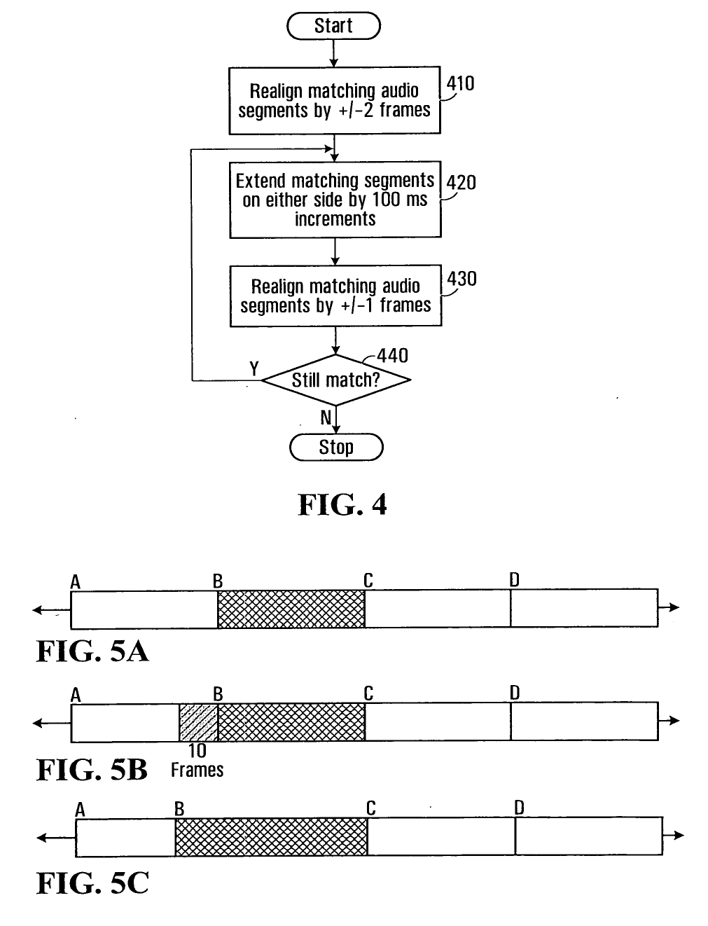

In practice it is unlikely that repeated audio content, such as an advertisement, falls entirely within a single audio segment in a stream or even within multiple contiguous audio segments. Furthermore, audio segments in different audio streams that contain the repeated content may be offset in time. FIG. 4 illustrates this situation, where a segment in the lower audio stream starts much later than its matched counterpart in the upper audio stream.

FIG. 4 illustrates a process that can be used to extend matching content of an audio segment in order to find its start and end points. Step 410 of this process represents the detailed-matching process, namely where the alignment of the audio segments is varied by +/−2 frames in order to get a finer alignment. At each shift, a matching between the audio segments is performed (such as by using the detailed-matching process discussed above) to determine if the match is made better or worse. If the match produces a better result, then the re-alignment is retained. Otherwise, the audio segments are shifted back to their original relative positions.

Once finely aligned, as discussed above the matching segments are extended on one side (i.e., their start and end points) by incrementing them by 10 frame (100 ms) segments, which is represented by step 420. Although 10 frame (or 100 ms) segments are identified here, segments with longer or shorter durations could be used without departing from the spirit of the invention.

At step 430, the segments are realigned by +/−1 frame to get a finer alignment. As before, matching between the audio segments is performed to determine if the match is made better or worse. If the match produces a better result, then the re-alignment is retained. Otherwise, the audio segments are shifted back to their original relative positions.

The process then determines if the extended audio segments still match by performing the process represented by step 440 (e.g., the detailed matching process). If so, the steps 420 and 430 are repeated more until there is no longer a match, at which point at least one of the ends of the segment with repeating content would be identified. The other end of the segment with repeating content is found using the same process from the other side.

More specifically, the process for assessing if a match is present after the audio segments have been augmented by 10 frames on one side, involves, for each 100 millisecond segment component, computing the absolute sum over all the frames of the differences in the corresponding cepstral values. The 10-frame alignment is then shifted by +/−1 frame to find the alignment with the lowest sum (best alignment), as the +/−1 frame alignment allows for any differences in frames during a re-broadcast. This sum is then compared against a matching threshold that, in one example is set at 60% of the absolute sum of the cepstral coefficients of the frames in the extended 100 ms window of the content being searched. Setting the threshold at this value has been found satisfactory as it leads to very low error rates in matching.

If the matching threshold is achieved, the segments are realigned according to their new starting point, which is likely 10 frames (100 ms) earlier than the previous starting point, and the prior steps in the technique are repeated to evaluate whether the frames prior to this new starting point also match. This process continues until the starting and ending points for each of the matching audio segments with repeated content are so determined.

In a non-limiting example, assume that a 20-second advertisement that is known to repeat elsewhere in an audio stream is spread across four 5-second audio segments A, B, C and D that are illustrated in FIG. 5A. Further assume that the fast-matching and detailed-matching process have correctly identified segment B as matching content elsewhere in the audio stream, but these account for only 5 seconds of the 20-second advertisement.

The extension process described above is illustrated by FIGS. 5B and 5C. This process begins in FIG. 5B where the starting point of segment B is extended by 10 frames (100 ms) backward in time into segment A. (It should be understood that FIGS. 5A, 5B and 5C are provided for illustrative purposes and are not drawn to scale.) The content of this 10-frame slice would be compared to 10-frame slice just prior to segment B in FIG. 5A. If these two 10-frame slices are deemed as a match, then they come from the same advertisement and the starting point of segment B is now set at the current position.

Another iteration of the extension process is then performed to compare the next 10-frame slice that lie beside the new starting point. Further iterations of this process continue until the starting points for the repeated segments are located. A similar process is followed to locate the end points of the repeated segments as only one side of the segment is extended at a time.

### Discrimination of Non-Matching Content

Although steps 120 to 140 allows the identification of a certain type of repeating content (e.g., advertisements) within the audio stream (or across audio streams), there is a possibility that similar instances of the same type of content are present in the audio stream but that do not repeat, or are not repeated within the duration of the audio stream that has been buffered. At step 150, this content can be identified, or at least a discrimination can be made between different content types, through the use of a different approach than the fast-matching and detailed-matching processes used previously.

As used here, “non-repeating” content refers to content that is not repeated within the timeframe of the audio stream (or streams) being buffered and analyzed at any one time. In the case where the type of content is advertisements, this situation may occur because commercial radio or TV stations typically sell their advertising time based on the number of repetitions. Thus, a first advertiser with a larger budget can afford to repeat their advertisements frequently on more stations than would be the case for a second advertiser with a smaller budget. As a result, advertisements of the first advertiser are more likely to be identified as repeating content by the fast-matching and/or detailed-matching processes than those of the second advertiser.

A similar situation may also be seen with public-service announcements (PSAs), which are a special type of advertisement typically broadcast as a public service by a radio or TV station, such as to promote seatbelt use or discourage drunk driving. Although a commercial radio or TV station is often mandated to repeatedly broadcast a certain number of PSAs per day, the frequency of repetitions for PSAs is typically far lower than that for commercials. As a result, PSAs are unlikely to be identified by the fast-matching and/or detailed-matching processes due to their low frequency of repetition.

Since a significant percentage of all advertisements may consist of such non-repeated content, a different approach would be beneficial to identify this type of content within an audio stream. One such approach involves the use of Gaussian mixture models (GMMs) to discriminate between certain types of content (e.g., advertisements) and other types of programming in the audio stream, such as news interviews, weather reports or traffic updates, among others. Having the capability to discriminate audio segments based on their content type (e.g., advertising versus other types of programming) this capability could help detect audio segments that do correspond to the type of content sought (e.g, advertisements) but that are not repeated frequently, such as commercials and PSAs with low number of repetitions. Such a capability could also help reject repeated audio segments that are not of the type sought, such as segments that are not advertisements.

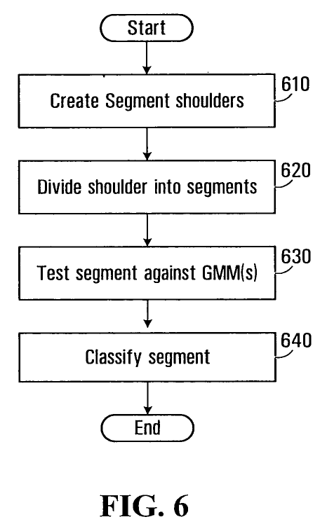

FIG. 6 is a block diagram showing the steps in an approach that involves GMMs analyzing an audio stream to discriminate between two types of content, namely between advertising and non-advertising (typically programming) content. At step 610, a ‘segment shoulder’ of a consistent duration is created on either side of a segment containing repeated content (such as advertising) that was identified during steps 120 to 140. The duration of each shoulder may be predetermined and is preferably 120 seconds (2 minutes), but can be adjusted on an as-needed basis. As a result, the first shoulder encompasses the up to 2 minutes of audio data labeled as non-advertisement before the repeated content (e.g., an advertisement), while the second shoulder encompasses up to 2 minutes of audio data labeled as non-advertisement following this content.

At this point, the content within these shoulders is still considered to be non-advertising programming. However, it is quite likely that these shoulders contain non-repeating advertisements since advertisements within an audio stream are typically grouped together to form an advertising ‘chunk’ that may be several minutes in length.

At step 620, the audio content within each shoulder is divided into a number of audio segments of consistent duration. While the duration of these shoulder segments is preferably 10 seconds, other durations can be used without departing from the spirit of the invention.

At step 630, the audio segments created in the previous step are evaluated by two GMMs that were trained on a training set of audio segments in order to discern the likely content of the segment. One GMM is trained to identify advertising segments while the other GMM is trained to identify programming (i.e., non-advertising) segments. The two GMMs that can be used for this step may be 256-mixture GMMs with 26 feature parameters (12 cepstral+energy+13 delta). The training and use of such GMMs is known in the art and therefore need not be discussed here.

During this step, each GMM evaluates each of the shoulder segment created in the previous step and assigns it a score indicating how likely the content of the evaluated segment corresponds to an advertisement in the case of the advertising-trained GMM, or to non-advertisement programming in the case of the programming-trained GMM.

At step 640, the segment is then classified as an advertisement or as (non-advertisement) programming based on its highest received score, which indicates whether the GMMs felt it was more likely to be an advertisement or programming. In this way, each segment within the segment shoulder can be classified as representing either an advertisement or (non-advertisement) programming. By performing this technique for each segment comprising the shoulder, non-repeating advertisements can be found and boundaries between non-advertisement programming (e.g., news updates, fictional shows, weather reports) and groups of repeating and non-repeating advertisements can be discerned within the audio stream.

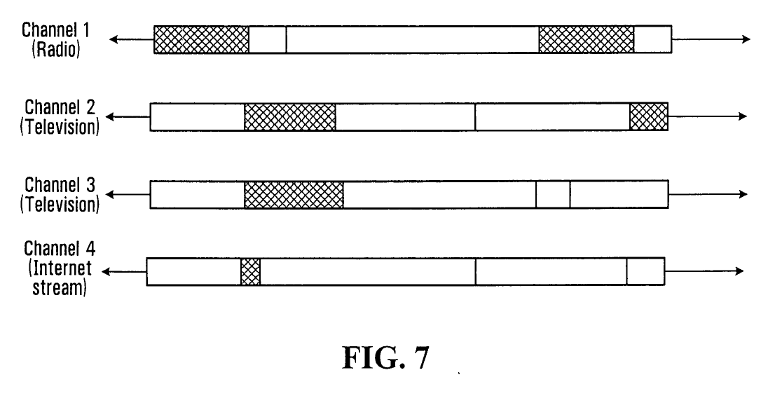

FIG. 7 shows the result of this process for four audio streams (one radio station, two TV stations, and one Internet streaming media channel) where the type of content is advertisements. The dark segments within the stream represent advertising chunks containing both repeating and non-repeating advertisements that were identified using the steps 120 to 150 described above. Content in the lighter shaded areas indicates non-advertising programming, such as news broadcasts, traffic updates, weather reports and both fictional and non-fictional shows, among others.

### Re-segmentation of Content

Returning to FIG. 1, at step 160 a re-segmentation process is performed. To refine the alignment between the types of content, a Viterbi re-alignment technique may be used. During this re-alignment, the boundaries between segments may be moved but the number of segments and their labels (i.e., advertisements or non-advertising programming) remained unchanged and each audio segment can be constrained to be at least 1 second long.

Each segment in the audio is modeled by a GMM (Gaussian mixture model). This GMM is trained by adapting the corresponding GMM (GMM for advertisement if it is an advertisement segment, otherwise GMM for program) to this segment using MAP adaptation, which is well known in the speech-recognition literature. The best possible segmentation of the audio is then obtained using these models with the help of Viterbi algorithm. The Viterbi algorithm is constrained to allow each segment to be at least 1 second long, and generate the same number of segments in the same order.

Several iterations of the Viterbi re-alignment may be necessary to adjust boundaries between segments accordingly.

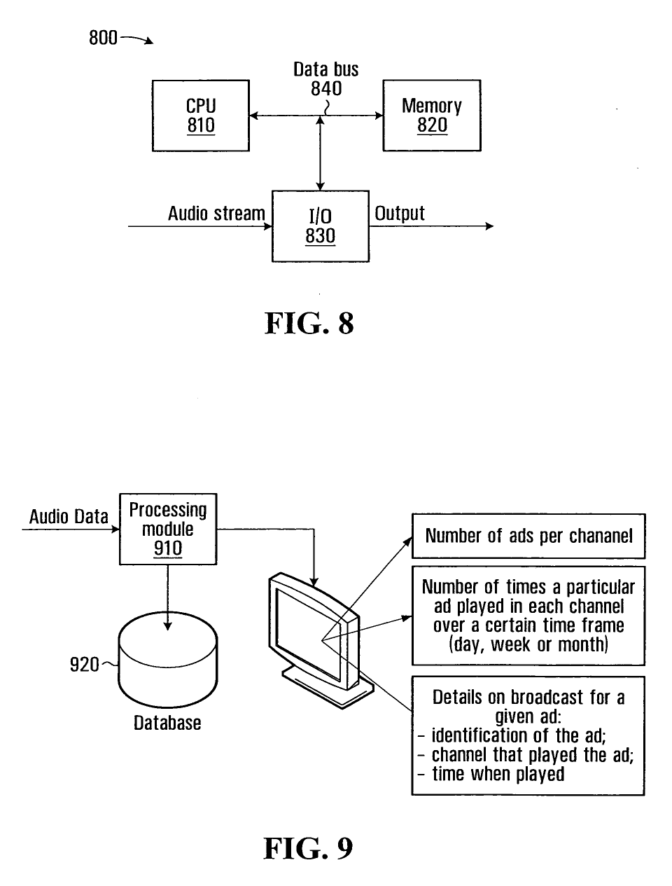

FIG. 8 shows a specific non-limiting example of a system 800 that can be used to implement the method described above. This system includes a CPU 810, a memory 820, an Input/Output (I/O) interface 830 and a data bus 840 that interconnects the other components of the system 800.

The CPU 810 is able to access software that is stored in the memory 820 and interact with external devices via the I/O interface 830. The memory 820 stores the software accessed by the CPU 810 and may also act as a buffer or storage area to store incoming audio stream(s) received by the I/O interface 830. The I/O interface 830 receives media streams at its input(s) and provides an output through which the CPU 810 and/or the memory 820 may access external devices. The I/O interface 830 may also provide access for the system 800 to a network (not shown), which may be a private network or a general public network, such as the Internet. The I/O interface 830 also allows connection of a user interface to the system 800 such as a display to show results or data derived from the processing and also to allow input of data into the system 800.

The data bus 840 provides a means for the CPU 810, the memory 820 and the I/O interface 830 to interact. Through this component, the CPU 810 can access the memory 820 and the I/O interface 830 (and vice-versa) in order to implement the method described above.

Certain non-limiting embodiments of the method and system identified above will now be presented. These embodiments are provided for illustrative purposes only and should not be construed as applying limitations to the scope of the invention.

FIG. 9 shows one such non-limiting embodiment that can be used to detect and generate reports on advertisements transmitted by a radio or TV station, or through streaming media provided over the Internet, Although this embodiment can be used to find content within an audio stream representing advertisements, the embodiment could be used to find other types of content.

In this embodiment, audio data (which may include one or more audio streams) is received by a processing module 910, which is connected to a database 920. It should be understood that the components 910 and 920 could be implemented via the system 800. In particular, the processing module 910 could be implemented through the CPU 810, the database 920 could be stored in the memory 820 and the audio data provided to the processing module 910 by the I/O interface 830.

The audio data, and more particularly the audio streams within it, are processed by the processing module 910. Several processing strategies are possible.

One processing strategy is to identify the audio segments within the stream corresponding to certain repeating and non-repeating content. Under the assumption that the repeating content is advertisement content, that content can be compared against a specific set of advertisements that are stored in the database 920. The purpose is to match specific advertisements in the database 920 to repeating content to determine if and how many times an advertisement is present in the media stream (which corresponds to the number of times that an ad was actually broadcast).

The second step, namely the matching of the repeating content with specific ads is done by using the same process discussed earlier. Specifically, the database 920 contains the audio content of each advertisement to be monitored, which is stored in any suitable format. The processing involves comparing the audio stream of each advertisement to be monitored with the repeating segments to determine for a given repeating segment, the ad matching that segment. Again, the comparison is made by using the methodology discussed earlier. Conceptually, the processing is generally equivalent to the example described in connection with FIG. 2, showing how several audio streams are processed in parallel to identify repeating content. In the present case, the audio content of each advertisement constitutes an audio stream, as well as the audio stream of the repeating content. If one or more of the audio segments from an advertisement to be monitored are found in the audio stream with the repeating content, then the system 800 may concludes that the repeating content corresponds to that particular advertisement.

Another possibility is to compare in real time the audio content of the advertisements to be monitored in the database 920 to the audio content that is broadcast, without previously distinguishing in that audio content those audio portions that repeat from those audio portions that do not repeat. In such case, if one or more audio segments from an advertisement to be monitored are matched to one or more audio segments in the broadcast, then the system determines that the advertisement is being played.

If the database 920 identifies an advertisement in the audio stream(s) that is stored in the database 920, it may record this result, as well as other relevant information, such as:
the channel/station from which the audio stream originated;
the time at which the advertisement was aired;
whether the advertisement was broadcast in its entirety, was arbitrarily cut off or contained gaps or distortions;
the placement of the advertisement within a group of advertisements in which it was broadcast (e.g., first, second, last); and/or
the advertisement(s) that preceded and/or followed the matched advertisement.

It is understood that the above list of information that can be compiled by the database 920 is non-limiting as other possibilities exist that would fall within the scope of the invention.

Yet another possibility is to combine the two strategies above in order to find existing advertisements as well as identify new advertisements from an audio stream (or streams). In this case, the database 920 supplies audio data for each individual advertisement as a first audio stream (e.g., the stream 210 in FIG. 2), which is then compared against the audio stream from the mass-media station or channel being monitored using a first iteration of the processes described previously. In this fashion, the presence of advertisements that are known and stored within the database 920 can be detected and flagged within the audio stream.

However, it is possible that the audio stream being monitored (i.e., the one from the mass-media station or channel) also contains certain advertisements that are not within the database, such as new advertisements. To detect such advertisements, a second iteration of the processes identified above are applied those segments of the audio stream(s) that were not flagged as being a known advertisement in order to find new repeating and non-repeating advertisements that may lie within the stream.

For example and with reference to FIG. 2, assume that the audio stream 210 contains audio data for known advertisements from the database 920, while the audio stream 220 contains the audio data supplied by a radio station. Furthermore, assume that the segments 220B and 220D represent known advertisements that are stored in the database 920, while a new advertisement that is not in this database is repeated at the segments 220E and 220G.

During the first iteration of the processes described above, the known advertisements represented by the segments 220B and 220D are detected and flagged by comparing the content in the stream 210 with the audio data in the audio stream 220. These instances are noted by the database 920 in preparation for later report generation. However, the new advertisement at segments 220E and 220G is not detected at this point since its data is not within the database 920.

In preparation for the second iteration, the segments 220B and 220D are flagged as known advertisements, in order that the system need not re-compare these to other segments in the audio stream 200. Next, a second iteration of the processes described above are applied to the remaining segments within the audio stream, namely the segments 220A, 220C, 220E, 220F, 220G and 220H. During this iteration, the repeated content in segments 220E and 220G is detected using the fast-matching and detailed-matching processes. These segments (along with their segment shoulders) can then be tested via the GMMs identified previously to determine whether they represent advertisements or non-advertising programming. Upon confirmation that these segments represent do indeed represent advertisements, Viterbi re-segmentation can be performed to get better alignment between the new advertisements and their surrounding non-advertising programming, such that the entirety of the advertisement is known. However, because the advertisement was discovered during the second iteratiori, it may be concluded that this is a new advertisement and therefore is flagged with an appropriate tag, such as “new commercial” or “unknown ad”.

Upon discovery of the new advertisements during this second iteration, the processing module 910 may store audio data flagged with the “new commercial” tag separately and/or prompt a human operator (not shown) to review the advertisement and determine whether it should be added to the database 920. The processing module 910 may also record the discovery of the new advertisement to the database 920 in order that it (and its associated information) may be included in future generated reports.

Over time, a record of advertisements within the audio data is recorded, which can be processed to produce reports that may be useful to mass-media station or channel, to advertising agencies, as well as to advertisers. For example, the processing module 910 and the database 920 can also be used to process this data and generate reports, such as:
for a mass-media station or channel (e.g., TV station), the total number of advertisements played and/or the average number of advertisements played during a particular timeframe (e.g., number of advertisements per hour);
for a particular advertiser, a breakdown of where their particular advertisement(s) were broadcast, the times at which their advertisement(s) were played, as well as the frequency at which they were being played by a particular station or channel; and/or
for a particular advertisement, a breakdown of the stations/channels on which this advertisement was played during a particular timeframe (e.g., hour, day, week or month), the time at which the advertisement was broadcast, how often the advertisement was repeated during this period, as well as the general broadcast quality of the advertisement on a particular station or channel.

Again, it should be understood that the above list of generated reports is non-inclusive as other entries exist and would fall within the scope of the invention.

Reports for such parties may be generated automatically by the system 800 on a regularly scheduled basis and distributed via print or electronic means, such as by email. Alternatively, the parties themselves may generate such reports dynamically on an as-needed basis using a web-based interface available through the Internet. Through these means, users of such reports (such as advertisers, their representative advertising agencies, media brokers, mass-media outlets and/or media monitoring companies) can advantageously retrieve the information identifying advertisements in the monitored audio stream(s).

Being able to monitor audio data for advertisements and generate reports through automated means is advantageous for advertisers, as well as for the mass-media outlets that broadcast their advertisements. In particular, having an automated means to identify commercials within an audio stream frees up human operators who would otherwise have to listen to the stream to identify such advertisements. In addition, such a system is able to monitor and identify advertisements from multiple audio streams simultaneously, which is more efficient than a human operator, who can generally only monitor one stream at a time. Furthermore, having an automated means to monitor and identify advertisements broadcast on a radio station or TV channel may result in more accurate detection of such advertisements, especially during periods when a human operator may become bored or inattentive.

In the embodiment described above and illustrated in FIG. 9, the process terminates at the provision of generated report. In an alternative embodiment, however, the database 920 could alert the processing module 910 when an advertisement in the audio stream is positively identified in order that the module 910 could take some further action.

An example of one such further action that could be undertaken is the replacement of one advertisement with another. For example, assume that two versions of a radio commercial for a local car dealership are currently being broadcast: an older version with a car listed at a first price and a newer version where the same car is listed at a second lower price, and that both of which are recorded in the database 920. Further assume that the newer version of the commercial has not been received by all radio stations but the car dealership would prefer that this version be broadcast. If the database 920 positively matches an advertisement in the audio stream with the older version of the ad, it may alert the processing module 910 that this version should be replaced with the newer version, and supply the necessary audio recording. The processing module 910 can then replace the older version of the commercial with the newer version of the commercial to ensure that end-users hear that the car is listed at the second, lower price.

A related action to the above would be the replacement of certain types of advertisement with other types of advertisements or non-advertising information, according to user preferences. For example, a user may use the system to replace all car commercials (which they are not interested in) with other types of commercials in which they are more interested, such as for restaurants or sporting events. Sponsored non-advertising content, such as weather reports, news summaries or sports commentary, could also be used to replace advertisements of a certain type in a similar manner to that which is described above. In this way, an end user could “tune” their media stream to provide advertisements (and/or non-advertising content) that is attractive to them while still providing a revenue stream to mass-media stations and channels. Moreover, providing a delivery means by which a user can choose the form and type of advertising content that most appeals to them is advantageous to advertisers, as well as to mass-media stations and channels, which are facing increasing fragmentation of their traditional audiences.

Another example of a further action that could be undertaken by the processing module 910 could be the removal of the advertisement(s) from the audio stream altogether. In this case, if the database 920 identifies an advertisement within the audio stream, it could alert the processing module 910, which would then prevent the audio segments associated with a commercial from being output.

As an example, assume that a streaming Internet radio station provides its listeners with the choice of two versions: a free version that includes ads and a paid version that is ad-free. However, the streaming Internet radio station only needs to produce a single output, namely the free version that includes ads, because they can use the processing module 910 and/or the database 920 to selectively remove ads from an audio stream output that is directed for the users of the paid version.

Furthermore, where the audio segments are associated with video frames (e.g., in a TV show or Internet streaming video), the processing module could use the audio segments associated with the commercial to find and remove the corresponding video frames that are also associated with the advertisement. In this way, the processing module 910 and the database 920 may entirely remove both the video and audio components of advertisements from the output.

Up to now, the above description has been provided in the context of detecting and identifying advertisements, such as radio or TV commercials and/or public-service announcements. However, the method and system could be used to detect and respond to other types of audio content, such as music or songs. In particular, an embodiment of the method and system described above could be used to detect and identify copyrighted songs and music that is transmitted through peer-to-peer (P2P) file-sharing networks, such as BitTorrent.

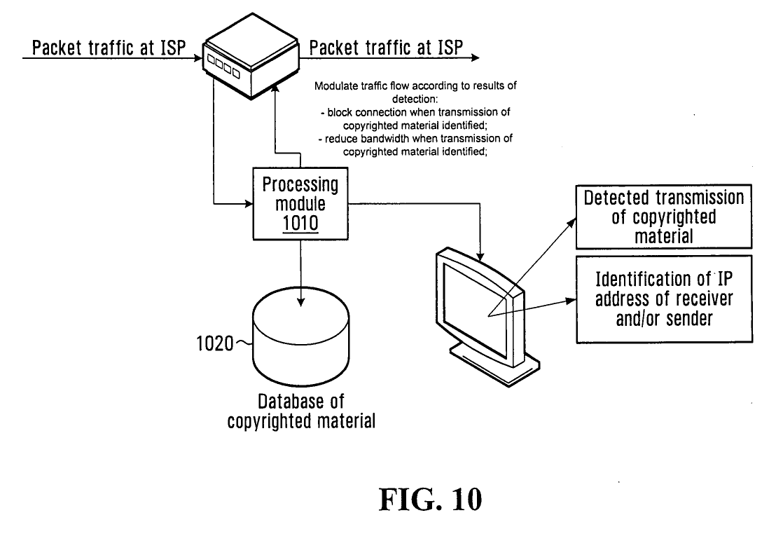

FIG. 10 shows one such non-limiting embodiment, which includes a processing module 1010 and a database of copyrighted material 1020. The processing module 1010 is similar to the processing module 910 but receives its audio data solely from a general data traffic stream identified as being related to P2P file sharing networks, and more particularly, from the data packets being delivered to the originator of a request for audio files, such as MP3 files.

The database of copyrighted material 1020 is also similar to the database 920 introduced with the prior embodiment, but contains copyrighted material (such as music and songs) rather than advertisements. Both the processing module 1010 and the database 1020 in this embodiment are linked to an Internet Service Provider (ISIP) who routes the data traffic related to P2P file-sharing networks through these components.

It should be understood that the components 1010 and 1020 could be provided by the system 800 described above. In particular, the processing module 1010 could be implemented through the CPU 810 and the database of copyrighted material 1020 could be stored in the memory 820 and the audio data (in the form of the data traffic stream) provided to the processing module 1010 by the I/O interface 830.

In general, files sent via P2P file-sharing networks are typically split up into multiple packets, which are reconstituted at the receiving end. As a result, a P2P traffic stream may contain packets for many different types of files, including files for potentially copyrighted music. However, since packets in this stream can be seen as being similar to the audio segments described previously, the processing module 1010 can treat them in an identical fashion. In particular, the processing module 1010 can identify segments (i.e., packets) corresponding to audio files from the data traffic stream and submit them to the database of copyrighted material 1020.

The database of copyrighted material 1020 compares the audio data in the segments submitted by the processing module 1010 against recordings of the copyrighted material stored within it. As before, if the audio data of a submitted audio segment(s) matches that of the copyrighted music associated with a record, the database 1020 determines that a positive match has been made and certain information may be recorded, including:
the song title, artist and/or publisher whose copyrighted work is being transmitted via the P2P file-sharing network;
the P2P file-sharing network being used to transmit the copyrighted work; and/or
the identification of the originator and destination, such as the IP addresses of the computer used to make the request and the computer used to fulfill the request.

The entries in the above list of information should be considered non-exclusive as other types of information could be compiled by the database of copyrighted material 1020 that would fall within the scope of the invention.

Over time, a record of copyrighted songs and music being transmitted through the data traffic stream associated with P2P file-sharing networks can be generated. The processing module 1010 and the database 1020 can also be used to interpret this data and generate reports, including a list of music titles, artists and publishers that are most frequently being transmitted via the P2P file-sharing networks and/or a list of users (likely identified by their IP addresses) who are currently using the ISP to receive copyrighted material via P2P file-sharing networks. In addition, a list of the P2P file-sharing networks that are most often used to transmit copyrighted songs and music via the ISP, among other reports that can be generated from the database 1020.

As before, the embodiment illustrated by FIG. 10 may be used by the ISP (or by an associated organization) to simply compile statistics and/or generate reports from the database 1020 that may be acted upon elsewhere. For example, the ISP could use these reports as evidence to suspend or remove the most flagrant violators of copyrighted material. Alternatively, they may choose (or be forced) to hand these reports over to law enforcement authorities in order that legal action be taken against users who violate applicable copyright laws.

However, it is also possible that the database of copyrighted material 1020 could alert the processing module 1010 in the case of a positive match indicating the transmission of copyrighted material via the P2P file-sharing network. In this case, the processing module 1010 could take certain further actions that could help prevent the copyrighted material from reaching its destination and/or deter the further provision of such material.

One further action that could be undertaken by the processing module 1010 upon detection of a positive match is to prevent the recipient from receiving any more packets related to the copyrighted music or songs. For example, the processing module 1010 could instruct the ISP to discard all incoming packets identified in the P2P traffic stream that are destined for the IP address of the recipient and that correspond to segments in the copyrighted song or music. This prevents the remaining audio packets from reaching the user's computer where they can be reconstituted as a music file.

Another further action that could be undertaken by the processing module 1010 is to instruct the ISP to throttle down the bandwidth available to the offending user (identified via their IP address) in response to the violation. For example, when a user is caught receiving copyrighted material via a P2P file-sharing network, the processing module 1010 could instruct the ISP to cut the flow to the user to a fraction of the original bandwidth, causing Internet-related applications, such as browsers and P2P clients, to appear to dramatically slow down. This could prevent the user from receiving not only the remaining packets for the copyrighted song, but also packets for other songs, music, movies, software and images that are being transferred via P2P file-sharing networks.

In yet another action that could be undertaken by the processing module 1010, the module 1010 could replace some or all of the packets in the audio stream that are associated with the copyrighted song or music with other packets containing an audible warning, such as a popular artist saying “It's not cool to steal music!”. Although the music file would appear to be received in its entirety by the P2P client, the user would hear the warning when they attempted to play the song or music.

Through enabling such actions, the ISP may better comply with relevant local, state/provincial, federal or international laws regarding the transmission, detection and interception of such copyrighted material. The ISP may also be able to provide better information to interested parties, such as music industry organizations and/or law enforcement agencies who are often tasked with intercepting, deterring and prosecuting copyright offenders.

In the embodiment illustrated in FIG. 10, the database 1020 is likely to be updated on a regular basis by interested parties, such as music artists and publishers. In an alternative embodiment, however, a process is provided in which anyone, including members of the public, could add their own audio-visual media to the database 1020 in order to detect and monitor whether it is being transferred via P2P file-sharing networks.

In this alternative embodiment, a graphical user interface (not shown) is provided to allow a user to transfer their digital media (hereafter referred to as “user-created media”) to the processing entity 1010 and the database of copyrighted material 1020. The interface also provides a way to record information about the creator of the work, such as their name and contact details, as well as identify whether the user intends their work to be considered as copyrighted material.

The processing entity 1010 could then separate the audio data from the rest of the media stream (where necessary) and create a new record for the user-created media in the database 1020, including a recording of the audio data for comparison purposes.

The operation of the processing entity 1010 and database of copyrighted material 1020 continues in this alternative embodiment as described above, with the exception that audio segments from P2P file-sharing networks that are submitted to this database are also compared to user-created media, in addition to copyrighted songs and music. As before, if the audio data in the audio segment(s) matches that associated with a record, the database of copyrighted material 1020 determines that a positive match has been made and certain information may be recorded that would allow the user who submitted the media to generate reports showing which of their works being transmitted via the P2P file-sharing network, the P2P file-sharing network being used to transmit the media among others.

It should be understood that in this alternative embodiment, user-created media submitted to the processing module 1010 may not be subject to copyright, as this choice is left to the submitter of the work. By providing the user with this choice, the processing module 1010 can help educate potential artists about copyright laws, as well as help them protect and/or enforce their rights should they wish to do so.

1) A method, comprising:
a) receiving at a processing entity a media stream comprising an audio segment;
b) performing a searching operation on an audio stream, the searching operation being operative for identifying a potential match to the audio segment within the audio stream;
c) conveying information indicative of the results of the searching operation.

2) A method as defined in claim 1, wherein said searching operation comprises repeatedly comparing the audio segment with successive portions of the audio stream in order to identify matching audio segments.

3) A method as defined in claim 2, wherein said searching operation comprises a first processing operation and a second processing operation, wherein the second processing operation is performed when the first processing operation identifies a potential matching audio segment.

4) A method as defined in claim 2, wherein the first processing operation comprises comparing characterization data of the audio segment against characterization data of successive portions of the audio stream.

5) A method as defined in claim 3, wherein the second processing operation comprises increasing a duration of the audio segment being compared against the potential matching audio segment.

6) A method as defined in claim 3, wherein the second processing operation comprises adjusting the boundaries of the audio segment being compared against the potential matching audio segment.

7) A method as defined in claim 2, wherein the audio segment is contained within the audio stream, the searching operation comprising repeatedly comparing the audio segment with successive portions of the audio stream from which it was extracted.

8) A method as defined in claim 2, wherein the audio segment is contained within a different audio stream from the audio stream on which the searching operation is performed.

9) A method as defined in claim 3, wherein the audio stream is one of a plurality of audio streams, the searching operation being performed on the plurality of audio streams simultaneously for identifying a match to the audio segment within at least one of the plurality of audio streams.

10) A method as defined in claim 1, wherein the audio stream on which the searching operation is performed is stored in a database.

11) A method as defined in claim 1, wherein the searching operation is operative for identifying whether the audio segment may be considered copyrighted material.

12) A system, comprising:
a) a processing entity operative for:
i) receiving a media stream comprising an audio segment;
ii) performing a searching operation on an audio stream, the searching operation being operative for identifying a match to the audio segment within the audio stream;
b) an output operative for conveying information indicative of the results of the searching operation.

13) A system as defined in claim 12, wherein the searching operation performed by said processing entity comprises repeatedly comparing the audio segment with successive portions of the audio stream in order to identify matching audio segments.

14) A method, comprising:
a) receiving at a processing entity a first media broadcast and a second media broadcast;
b) identifying advertisement content in the first media broadcast by detecting audio segments in the first media broadcast that match at least one audio segment in the second media broadcast.

15) A method as defined in claim 14, wherein detecting audio segments in the first media broadcast that match audio segments in the second media broadcast comprises repeatedly comparing an audio segment in the first media broadcast with successive audio segments in the second media broadcast.

16) A method as defined in claim 14, wherein detecting audio segments in the first media broadcast that match audio segments in the second media broadcast comprises performing a first processing operation and a second processing operation, wherein the second processing operation is performed when the first processing operation identifies potential matching audio segments.

17) A method as defined in claim 16, wherein the second processing operation comprises increasing a duration of the audio segments being compared.

18) A method as defined in claim 14, further comprising receiving at the processing entity a third media broadcast, and identifying advertisement content in the first media broadcast by detecting audio segments in the first media broadcast that match at least one audio segment in one of the second media broadcast and the third media broadcast.

19) A method as defined in claim 14, further comprising extracting from the first media broadcast an audio stream which contains a plurality of audio segments.

20) A method comprising:
a) receiving at a processing entity a media broadcast comprising programming content and advertisement content;
b) processing the media broadcast using a Gaussian Mixture Model (GMM) in order to discriminate between programming content and advertisement content.
